(19) United States
(12) Patent Application Publication
(10) Pub. No.: US 2008/0156455 A1
(43) Pub. Date: Jul. 3, 2008

(54) HEAT EXCHANGER MANIFOLDS WITH RETENTION TABS

(76) Inventors: Michael V. Powers, Lakewood, NY (US); Jonathan T. Fitzgerald, Warren, PA (US); LaVoyce G. Dey, Youngsville, PA (US)

Correspondence Address: JULIA CHURCH DIERKER;DIERKER & ASSOCIATES, P.C., 3331 W. BIG BEAVER RD. SUITE 109, TROY, MI, 48084-2813, US

(21) Appl. No.: 11/956,997

(22) Filed: Dec. 14, 2007

Related U.S. Application Data
(60) Provisional application No. 60/874,769, filed on Dec. 14, 2006.

(51) Int. Cl. F28F 9/02; F28D 1/02; B23P 15/26; F28F 9/00

(52) U.S. Cl. 165/67; 165/153; 29/890.052; 165/158

(57) ABSTRACT

Heat exchanger assemblies, and in particular, heat exchanger assemblies for automotive vehicle applications are disclosed. The heat exchangers have manifolds with retention tabs for brackets, caps and other components, such as attachment elements.

### CROSS-REFERENCE TO RELATED APPLICATIONS

This application claims the benefit of U.S. Provisional Application Ser. No. 60/874,769, filed Dec. 14, 2006, which is incorporated herein by reference in its entirety.

### BACKGROUND

The present disclosure relates generally to heat exchanger assemblies, and more particularly to assemblies including brazed heat exchangers having at least one manifold and attachment features.

In modern vehicle cooling systems, the typical oven brazed heat exchanger consists of a fin and tube assembly called the core. The core tubes are attached to core headers on opposing ends of the core. The whole assembly is heated in an oven, thereby bonding together the fins, tubes, and header. The remaining tank portions are attached to the headers to form manifolds by welding or by a mechanical crimping process, depending on the header design and the material composition of the tank portion. The tank portions can be molded plastic, metal die castings, or formed from flat sheet stock. The plastic tank bracket locations are generally limited, because they are molded above the foot areas spaced beyond the header to provide room for the crimp bar. Metal tanks are welded to the header, and the brackets are cast into or welded onto the tank.

FIG. 1 illustrates a prior art heat exchanger having plastic tanks and having a core (110), header (111), gasket (116) between header (111) and tank foot (113) of tank (114). Inlet/outlet (115) is also illustrated.

FIG. 2 illustrates a prior art heat exchanger with a cast metal tank (124) welded to the header (121) at welded seam area (127), with inlet/outlet (125) and heat exchanger core (120) illustrated.

Manifolds on such assemblies often require substantially increased packaging space along the direction from grill to engine at the plastic tank to header crimped connection. In such assemblies, additional operations after brazing are required to weld cast tanks and/or to crimp a plastic tank with gasket to the header. Cast brackets and other hardware attachment features formed on the tank are often restricted in shape and location because of molding process limitations such as die draft and die pull restrictions.

Also, current brazed heat exchanger assemblies often have manifolds produced from flat sheet stock that require controlled clearances to substantially ensure the bond strength reliability at braze junctions. Tack welding and/or fixtures for the brazing operation result in varying degrees of integrity within the braze junction. Heat exchanger tanks and covers require even better gap clearance control than manifolds to create braze seal around the perimeter.

In addition to these difficulties, brackets and/or attachments are often affixed after the brazing operation to avoid further complications. However, such after-braze affixation often results in additional manufacturing and/or assembly operations, with associated fixture problems, additional handling steps and/or welding needs.

### BRIEF DESCRIPTION OF THE DRAWINGS

Features and advantages of embodiments of the present disclosure will become apparent by reference to the following detailed description and drawings, in which like reference numerals correspond to the same or similar, though perhaps not identical, components. For the sake of brevity, reference numerals having a previously described function may or may not be described in connection with subsequent drawings in which they appear.

FIG. 1 is a section view of a prior art heat exchanger with a plastic tank, gasket and sheet metal header assembly with header crimp tabs retaining the tank and gasket;

FIG. 2 is a section view of a prior art heat exchanger with a cast tank and sheet metal header assembly with a header to tank welded seam to retain the tank;

FIG. 3 is an isometric view of an aspect of the present disclosure in its one-shot braze form showing a sheet metal header and cap with tabs and a bracket with tightly fitting formed slots that assemble on to the manifold sidewall projected tabs with a secondary foot held in close to the tank;

FIG. 3A is an exploded, cutaway view of the mounting bracket and tabs of FIG. 3;

FIG. 4 is a section view cut through the sheet metal manifold (see FIG. 3) showing a cap and retention tab with lead-ins, control channel and channel end radius, the cap being shown with reinforcement ribs running fore to aft in the manifold, in accordance with an aspect of the present disclosure;

FIG. 4A is an enlarged, cutaway view of the area of circle 4A in FIG. 4;

FIG. 5 is an isometric view of the sheet metal manifold end (see FIG. 3) showing embodiment(s) of “manifold sidewall to cap braze seam gap clearance control” cap tabs and “cap end alignment” and “cap end retention” header tabs, in accordance with an aspect of the present disclosure;

FIG. 6 is a section view cut through the manifold (see FIG. 3) showing the bracket attachment to the header wall protruding tabs;

FIG. 6A is cutaway view of FIG. 6, showing the option of cutting and or bending the bracket to avoid interference within the engine compartment, in accordance with an aspect of the present disclosure;

FIG. 7 is a cutaway side view showing installation of optional bracket retention features where the manifold assembles snugly between the parallel faces of the attaching brackets and in various planes relative to the external manifold contours, in accordance with an aspect of the present disclosure;

FIG. 7A is an enlarged, cutaway view of the area of circle 7A in FIG. 7;

FIG. 8A is a cutaway side view showing a manifold with an optional method for attaching an extruded bracket to the external wall of the manifold by a mechanical staking process before assembly of the manifold cap to the header, the bracket being shown with self-locating features to match the contour of the manifold wall, in accordance with an aspect of the present disclosure; and

FIG. 8B is a cutaway, top view of the manifold of FIG. 8A.

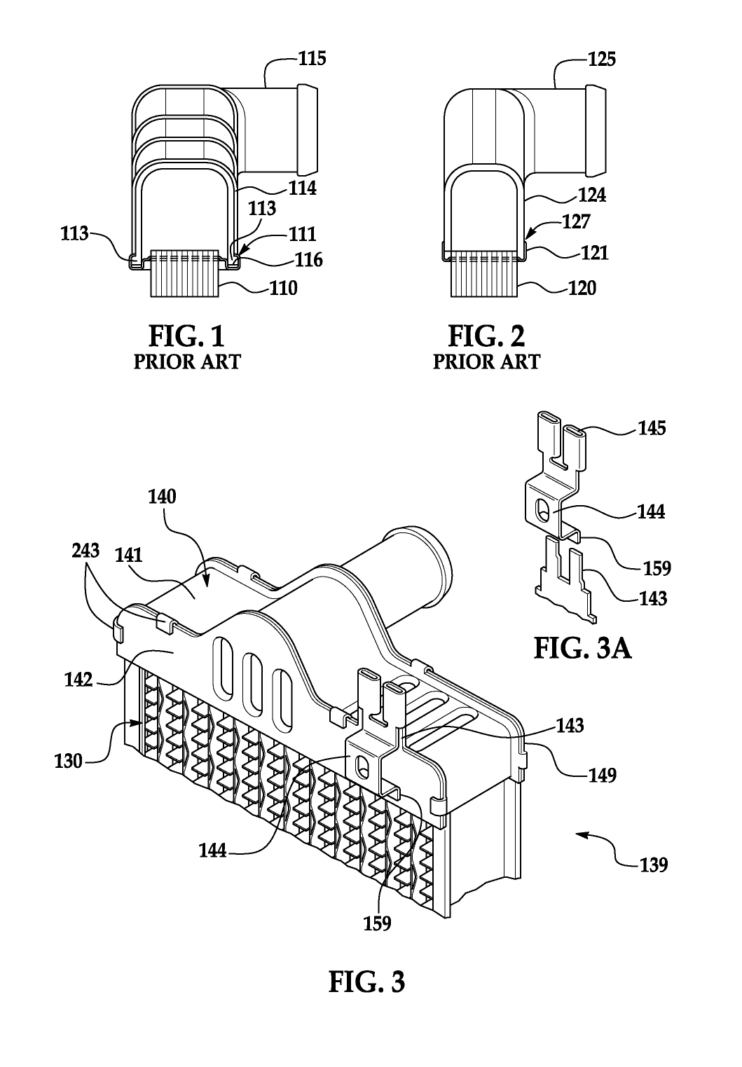

### DETAILED DESCRIPTION

Aspects of the present disclosure include heat exchanger assemblies and, in particular, heat exchanger assemblies for automotive vehicle applications, wherein the heat exchangers have manifolds with retention tabs for brackets, tank covers and other components.

Further, aspects of the present disclosure lead to designs for heat exchanger assemblies that, in spite of the potential problems associated with brazing and assembly, provide for integrity of the braze junction of the heat exchanger manifold cap and manifold sidewall throughout the perimeter of the seam of the junction, and provide fixtureless methods of attaching brackets, covers and other components for brazing all the features at one time.

The present disclosure, in various aspects, provides for a stronger manifold by providing a robust overlapping, double-wall flange, and substantially insuring the reliability of the braze joint at the area of manifold cap-to-sidewall connection. By using contoured areas of the manifold to affix components prior to brazing, the requirement for after-braze operations and the additional handling requirements associated with affixation of brackets, covers and other components in the manufacturing operations, may be eliminated.

In various aspects of the present disclosure, a heat exchanger assembly is provided having a manifold including a cap, sidewall, and header. In various embodiments, no additional fixtures (a fixtureless application) are required. By providing for fixtureless attachment of components such as caps, mounting accessories and the like, an assembly with manifold closure cap and mounting accessories may be assembled in one brazing operation, thus substantially assuring that first time placement of features yields accurate mounting features on the overall assembly, and reduced handling time for final assembly of product.

As described above, heat exchanger assemblies of aspects of the present disclosure, and, in particular, heat exchanger assemblies having components such as manifold caps, are provided with the maximum of components affixed or otherwise attached together prior to brazing. In an example, flux may be applied to the core, manifolds, inlets, outlets, mounting features, etc. before brazing. In another example, the caps or cap portions of the manifold may be attached to fore and aft manifold sidewalls after fluxing to permit fixtureless assembly and reduced handling time for final assembly of products. As yet another example, a manifold and cap can be assembled to a header after fluxing, substantially insuring a uniform flux coating in the braze area. By providing a header and cap with attachment features, fixtures (such as welding jigs or brazing frames) are no longer required. The present inventors have advantageously found that fixtureless assembly of brackets to the manifold is possible by locating tabs strategically within the manifold cap and manifold sidewall themselves. The dimensions and location of the tabs control the spatial relationship between mating surfaces to substantially ensure proper brazing clearances. This allows the braze material to melt and fill the gap between mating surfaces through capillary action during brazing.

The manifold itself, in various aspects of the present disclosure, includes fixtureless features allowing for fixtureless attachment of mounting accessories, such as brackets. By providing for fixtureless attachment of mounting accessories prior to brazing, the heat exchanger assembly can be completed in one brazing operation, thus maintaining accurate mounting features on the overall assembly. In the case of brackets, the location of the tabs or recessed features controls the spatial relationship between the manifold and brackets. This substantially ensures that the bracket is located properly on the manifold, thus providing for correct installation of the heat exchanger in the vehicle.

The component-attached parts are all made from similar braze sheet metal composite alloys as the core and manifold sheet metal, which makes recycling the heat exchangers more environmentally friendly, because heat exchanger disassembly for segregation of component materials is not required.

In an example, an automotive heat exchanger can have attachments and/or mounting features affixed to the heat exchanger prior to brazing. In that case, the manifold assembly of the heat exchanger can be composed of components made of chemically similar material composition. This allows the core, manifold components and mounting brackets to be recycled together without requiring disassembly and selective separating at reclamation of components for environmental recycling of discarded assemblies.

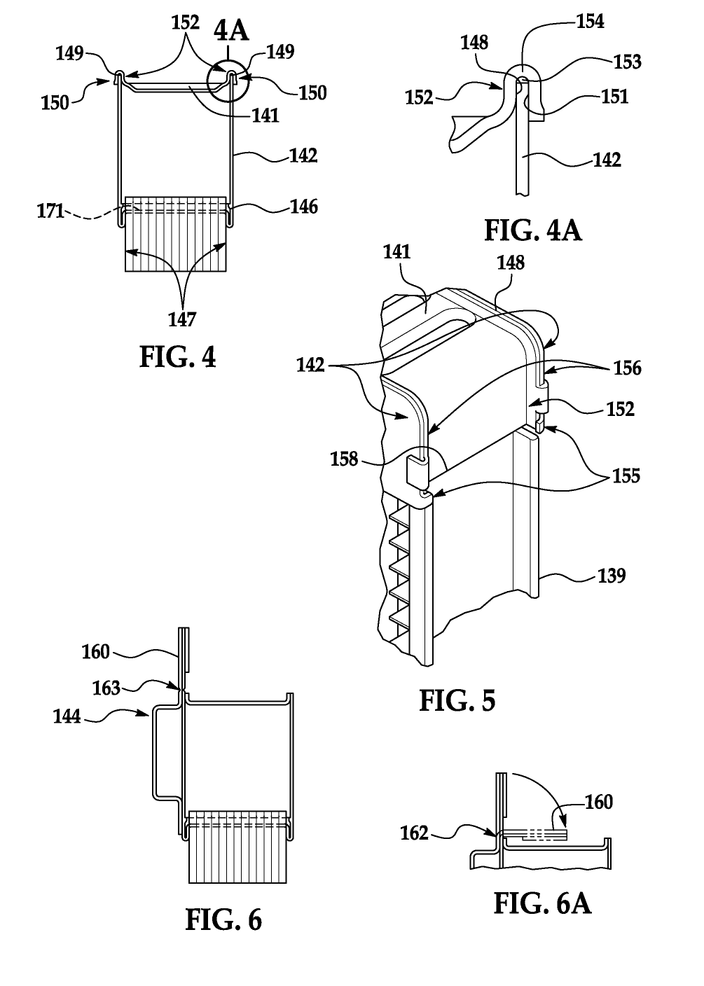

Referring now to the Figures, FIG. 3 illustrates a heat exchanger assembly, including a heat exchanger (139) having a manifold at each end of a core (130). The manifold (140) includes a cap (141) and sidewall (142) assembly connected to a header (171, shown in FIG. 4), which is in turn connected to the core (130), which includes core tubes parallel to each other. In some embodiments, fins are positioned between the tubes. A first header is attached to one end of the core and at the end of the plurality of tubes. A second header is attached to the second end of the core and at the opposite end of the plurality of tubes. The manifold assembly (140) is, in this embodiment, formed from flat sheet metal stock. In a further embodiment, the manifold assembly (140) is made from aluminum sheet stock. In yet a further embodiment, the manifold sidewall (142) and header (171) are formed in one piece from sheet metal stock. In other embodiments, the manifold sidewall and header could be separate pieces joined by brazing, welding, or mechanical means. For example, in one embodiment, the manifold assembly (140) is formed from a metallic material, i.e., the header (171), the side walls (142) and the cap (141) are formed from a metallic material (e.g., aluminum) and are brazed to each other.

FIG. 3 also shows a heat exchanger manifold sidewall (142) with vertical projections or tabs (143) to receive components, such as mounting brackets (144). The bracket (144) or other component has slotted features (145), sized so as to slide over the tab projection during assembly, and to fit tightly in the final location and, therefore, solidly maintain or retain the component to the manifold assembly (140) throughout the final brazing of the assembly. The bracket would typically be used to mount the heat exchanger to a vehicle structure during final installation. Brackets could also be used to attach ancillary components such as surge tanks, fan shrouds, air shields and the like to the manifold as dictated by requirements for the application.

FIG. 4 shows the core side portion (the part of the manifold connected directly to the core) referred to as the manifold header portion (146) (including a header plate (171)), which is connected to fore and aft sidewalls (142) directed oppositely and extending away from the tubes and parallel to the heat exchanger core face (147). The sidewalls (142) may extend substantially perpendicularly to the header plate (171). The manifold side portion (the part of the manifold away from or opposite from the side of connection to the core, is shown in FIGS. 3 and 4 as a separate piece, herein described as a manifold cap (141), and has opposed vertical braze seam flanges (152) parallel to the manifold side walls (142). The manifold cap flanges extend in an approximately 90° bend from the edge of the manifold cap and lie in close proximity to the manifold edge portions of the manifold sidewalls. The outer edge profile of the manifold cap flange (148) approximately matches the manifold sidewall edge profile (149) in the area of the braze seam.

During assembly, a portion of the manifold cap portion flange braze surface lies in close proximity to the header portion inside of the vertical wall as they form a manifold shape so that the flange wall can uniformly bond and form a seal after brazing along the entire length of the flange.

In FIGS. 3, 3A, 4 and 4A, and in various aspects of the present disclosure, the heat exchanger assembly includes a heat exchanger having a heat exchanger manifold cap portion (141) and retention tabs (243) extending upward from a braze flange (152) at the edge of the cap (141) and bending back downward to form a “U” shaped channel-section (150). The channel-section has an inner surface (151) essentially parallel with the braze flange outer surface (152) at the edge of the cap (141). The channel is characterized as having an ‘opening’ (153) formed by the two sides of the U-bend. The width of the opening formed within the channel is within a range that would enclose the minimum material thickness of the manifold sidewall (142) at the cap braze area (154) including an allowable gap that would still provide conditions for an acceptable braze bond. In other words, the width of the opening (153) is such that the manifold sidewall can slide into the U-shaped channel, and in the final position any gap between the mating flanges of the cap and sidewall is sufficiently small that it will fill with braze material through capillary action during brazing.

In FIGS. 4 and 5, a manifold sidewall portion (142) of a heat exchanger (139) has cap end alignment tabs (155) located at the end edges (156) of the manifold sidewalls (142) bent inward to form approximately a 90° angle with the sidewall surface. The cap end alignment tabs (155) retain the ends of the cap braze flanges (152) inward. This provides additional alignment of the manifold cap (141), and sidewall (142) braze flanges, and the end edge (158) of the header (146) in the area at the ends of the manifold, where header, sidewall and cap form a junction. The end alignment is advantageous for substantially ensuring tight joints in this area, providing a leak-free seal after brazing.

The heat exchanger manifold shown in FIG. 3 also has manifold sidewall flange projections that could receive brackets for vehicle mounting for other accessories. The bracket would have slotted features (145), sized so as to slide over the tab projection during assembly, and to fit tightly in the final location prior to brazing. The attachment (144) also has a second portion, which is shown in FIG. 3 as a flat foot area (159) which upon assembly aligns its lower surface closely to the manifold surface, in this embodiment the manifold sidewall (142). Contact is maintained between the bracket slotted features and flange projections, as well as the bracket foot and sidewall, to substantially ensure adequate bonding of the bracket to the manifold after brazing.

Various other aspects of the present disclosure include methods for providing for assembly of attachments in heat exchanger assemblies. For example, a wall of the manifold can be matched with a mounting feature and/or attachment. The mounting feature and attachment can be clinched to the manifold wall prior to brazing. FIGS. 6 and 6A, for example, illustrate an assembled bracket (144) with tab area (160) projected and bent downward close to the main body (141) of the manifold, reducing overall vehicle package size to accommodate any clearance issues in the vehicle. As an alternative to bending, the tab (160) could be cut-off in this area and the projection area removed after braze. A portion (162) of the bracket bonding area would remain to provide an acceptable bond strength. A third alternative would be to include a coined groove (163) which is located on both the tank tab portion and directly across on the bracket component before braze. The extended portion of the brazed bracket assembly (160) can be easily broken off the main portion of the tank to form a reduced overall profile. The coined groove creates a stress concentration to ensure that the extended bracket portion (160) breaks at the desired location.

As an example, an automotive vehicle has an engine compartment and an automotive heat exchanger. The heat exchanger may have attachments and/or mounting features affixed to the heat exchanger prior to brazing. If, for example, the attachment is a bracket, the bracket may be cut or bent after braze to avoid interference with the engine compartment.

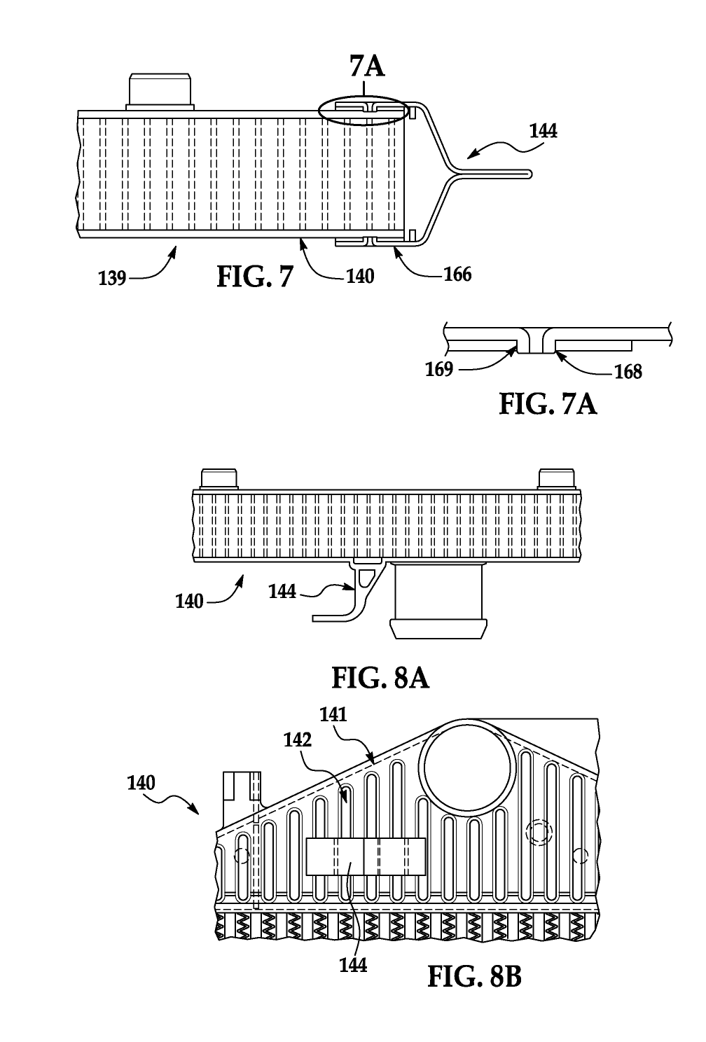

FIGS. 7 and 7A illustrate a heat exchanger assembly (139) having a mounting bracket attachment (144). A bracket retention sleeve area (166) wide enough to fit over the full width of the manifold (140) and, at a maximum, to a width equal to the minimum thickness of the manifold (140), is provided so that the assembly is a tight fit and the attachment position is maintained through brazing. In aspects of the present disclosure, the bracket (144) has a hole (168), and, particularly, an inwardly directed or pierced hole, which is flared at the edges to form a flange, extending inward towards the manifold, that can be aligned and snapped into a depression (169) on the manifold surface (140) to maintain a specific location and orientation.

FIGS. 8A and 8B illustrate two views of the heat exchanger (with FIG. 8A being a side view and FIG. 8B being a top view) with manifold sidewall (142) and cap (141), and a bracket (144) made of extruded aluminum with a profile matching the manifold surface profile at the area of attachment. The bracket (144) may be mechanically staked or clinched onto manifold sidewall mating features and held in place through an interference fit onto the manifold sidewall (142) in the aligned position, as required for vehicle installation, and remains affixed through brazing where it is bonded to the manifold (140). In other embodiments, the bracket could be attached similarly to other portions of the manifold, depending on the requirements of the application.

Unless stated otherwise, dimensions and geometries of the various structures depicted herein are not intended to be restrictive of the disclosure, and other dimensions or geometries are possible. Plural structural components can be provided by a single integrated structure. Alternatively, a single integrated structure might be divided into separate plural components. In addition, while feature(s) of the present disclosure may have been described in the context of only one of the illustrated embodiments, it is to be understood that such feature(s) may be combined with one or more other features of other embodiments, for any given application. It will also be appreciated from the above that the fabrication of the unique structures herein and the operation thereof also constitute methods in accordance with the present disclosure.

While several embodiments have been described in detail, it will be apparent to those skilled in the art that the disclosed embodiments may be modified. Therefore, the foregoing description is to be considered exemplary rather than limiting.

What is claimed is:

1. An automotive heat exchanger, comprising:
a core having a plurality of tubes substantially parallel to each other;
a first header attached to one end of the core and at one end of the plurality of tubes;
a second header attached to the second end of the core and at the opposite end of the plurality of tubes;
a first flanged manifold cap;
a second flanged manifold cap;
a manifold sidewall or manifold sidewall portion attached to the first header to form, with the first manifold cap, a first manifold;
a second manifold sidewall or manifold sidewall portion attached to the second header to form, with the second manifold cap, a second manifold;
at least one alignment tab on each manifold sidewall; and
at least one retention tab on each manifold cap;
wherein the first and second headers of the manifolds have the first and second manifold sidewalls extending away from the core and parallel to the core face, and wherein the first and second flanged manifold caps have at least one flange situated in a position opposite and adjacent to an end edge of their respective manifold sidewalls, and wherein the flanges have an outer edge profile that approximately matches the first and second outer end edge profiles of the first and second manifold sidewalls.

2. An automotive heat exchanger as in claim 1, wherein the manifold cap flanges are parallel to the manifold sidewalls and extend in approximately a 90° bend from the edge of the manifold cap.

3. An automotive heat exchanger as in claim 2, wherein the manifold cap flanges and the manifold sidewalls form a seal for brazing.

4. An automotive heat exchanger as in claim 3, wherein the manifold cap flanges lie in close proximity to edge portions of the manifold sidewalls.

5. An automotive heat exchanger as in claim 4, wherein the manifold cap flanges and the edge portions of the manifold sidewalls in close proximity to the manifold cap flanges form a shape in the manifold that uniformly bonds and forms a seal along an edge extending an entire length of the manifold cap flange.

6. An automotive heat exchanger as in claim 5, wherein the manifold cap has at least one retention tab extending outward from the seal formed by the manifold cap flange and the edge portions of the manifold sidewalls.

7. An automotive heat exchanger as in claim 6, wherein the at least one retention tab is folded or bent upon itself to form a channel with an inner surface parallel to a braze surface of the manifold seal formed by the manifold cap flange and the edge portions of the manifold sidewalls.

8. An automotive heat exchanger as in claim 7, wherein the at least one retention tab folded or bent upon itself forms a “U” shape.

9. An automotive heat exchanger as in claim 5, wherein at least one of the edge portions of the manifold sidewalls has at least one alignment tab, the alignment tab being at an angle of approximately 90° to a surface of the manifold sidewall.

10. An automotive heat exchanger as in claim 5, wherein the manifold caps and the manifold sidewalls are formed from flat sheet metal stock.

11. An automotive heat exchanger as in claim 6, wherein the manifold caps and the manifold sidewalls are formed from aluminum.

12. An automotive heat exchanger as in claim 5, wherein the manifold caps or manifold sidewalls comprise an attachment area of material extending from the surface of the manifold caps or manifold sidewalls, respectively.

13. An automotive heat exchanger as in claim 12, wherein the attachment area extends from the manifold sidewall edge portions to beyond the braze surface of the manifold seal formed by the manifold cap flange and the edge portions of the manifold sidewall, such that the seal is extended from the manifold sidewall edge portion to an extent that one or more attachments and/or mounting features can attach to the attachment area.

14. An automotive heat exchanger as in claim 13, wherein the attachments and mounting features are affixed to the attachment area prior to brazing.

15. A process for producing a brazed heat exchanger, comprising the steps of:
assembling a core comprising tubes and fins;
attaching headers, and caps or parts of caps to the ends of the core to form manifolds;
providing for at least one inlet and outlet to the manifolds;
affixing mounting features and components such as attachments, outlets, inlets, and connections; and
brazing the core, manifold, inlet manifold, outlets, mounting features and components simultaneously.

16. A process for producing a brazed heat exchanger as in claim 15, further comprising applying flux to the core, manifolds, inlets and outlets, and mounting features prior to brazing.

17. A process as in claim 16, further comprising attaching the caps or cap portions of the manifold to manifold sidewalls after fluxing to permit fixtureless assembly of cap tabs with the manifold sidewall.

18. A process as in claim 16, further comprising:
matching at least one wall of the manifolds with at least one of: at least one mounting feature; or at least one attachment; and
clinching the at least one mounting feature or attachment to the at least one manifold wall prior to brazing.

19. A process as in claim 16, wherein the at least one mounting feature comprises a bracket attachment, and wherein the process further comprises the step of at least one of cutting or bending the bracket attachment after braze to substantially avoid interference with an engine compartment.

20. An automotive heat exchanger comprising at least one of attachments or mounting features affixed to the heat exchanger prior to brazing, wherein the heat exchanger assembly has a heat exchanger manifold assembly, the manifold assembly including components formed from chemically similar material compositions such that the core, manifold components and mounting brackets can be recycled without requiring disassembly and selective separation at reclamation of components for environmental recycling of discarded assemblies.

21. An automotive vehicle having an engine compartment and an automotive heat exchanger, wherein the heat exchanger comprises at least one of attachments or mounting features affixed to the heat exchanger prior to brazing; and
wherein the attachment is a bracket, and the bracket is cut or bent after braze to substantially avoid interference with the engine compartment.

22. An automotive heat exchanger as in claim 1, wherein the manifold sidewalls and manifold header are fabricated as separate pieces, joined by brazing, welding, or mechanical means.

23. An automotive heat exchanger manifold assembly, comprising:
a header plate configured to have attached thereto a plurality of tubes of the heat exchanger;
a flanged manifold cap;
a manifold sidewall or manifold sidewall portion attached to the header plate to form, with the manifold cap, a manifold;
at least one alignment tab on each manifold sidewall; and
at least one retention tab on each manifold cap;
wherein the manifold sidewalls extend away from and substantially perpendicular to the header plate, and wherein the flanged manifold caps have at least one flange situated in a position opposite and adjacent to an end edge of the manifold sidewalls, and wherein the flanges have an outer edge profile that approximately matches the end edge profiles of the manifold sidewalls.
